(19) United States
(12) Patent Application Publication
(10) Pub. No.: US 2025/0030545 A1
(43) Pub. Date: Jan. 23, 2025

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventor: Yuuki OKAMOTO, Tokyo (JP)

(73) Assignee: NEC Corporation, Minato-ku, Tokyo (JP)

(21) Appl. No.: 18/714,620

(22) PCT Filed: Dec. 7, 2021
(86) PCT No.: PCT/JP2021/044915

§ 371 Date: May 30, 2024

(51) Int. Cl. H04L 9/32; G06F 11/36; G06F 21/32

(52) U.S. Cl. CPC H04L 9/32; G06F 11/3612; G06F 21/32

(57) ABSTRACT

An information processing system includes: a storage control unit that stores, in a storage unit, template information generated by performing an encoding processing using an encoding parameter, on first confidential information; a generation unit that generates test information, by performing the encoding processing using the encoding parameter, on second confidential information; and a matching unit that matches the template information with the test information.

### TECHNICAL FIELD

This disclosure relates to technical fields of an information processing system, an information processing method, and a recording medium.

### BACKGROUND ART

Patent Literature 1 describes a technique/technology of: obtaining first information corresponding to the first synthetic biometric data; obtaining first common synthetic data and second biometric data; generating second common synthetic data on the basis of the first information and the second biometric data; and selectively authorizing access based on a comparison of the first common synthetic data and the second common synthetic data. In addition, Patent Literature 2 describes a technique/technology of: storing a template to which a feature quantity of biometric information of a user is transformed by a parameter, in association with an ID; and comparing a one-time template generated by transforming a template corresponding to an ID transmitted from a server, with one of the transformed feature quantity transmitted from a client and data using the parameter transmitted from the server, to determine whether they match or not. In addition, Patent Literature 3 describes a technique/technology of: encrypting content by using an encryption key and generating management information that associates the encryption key with address information of a cloud storage, wherein a terminal device accesses the cloud storage without user authentication with reference to management information, downloads the encrypted content from the cloud storage, and decrypts the content from the encrypted content by using the encryption key.

### CITATION LIST

### Patent Literature

Patent Literature 1: JP2017-531237A
Patent Literature 2: International Publication No. WO2010/070787A1
Patent Literature 3: International Publication No. WO2013/111174A1

### SUMMARY

### Technical Problem

It is an example object of this disclosure to provide an information processing system, an information processing method, and a recording medium that aim to improve the techniques/technologies disclosed in Citation List.

### Solution to Problem

An information processing system according to an example aspect of this disclosure includes: a storage control unit that stores, in a storage unit, template information generated by performing an encoding processing using an encoding parameter, on first confidential information; a generation unit that generates test information, by performing the encoding processing using the encoding parameter, on second confidential information; and a matching unit that matches the template information with the test information.

An information processing method according to an example aspect of this disclosure includes: storing, in a storage unit, template information generated by performing an encoding processing using an encoding parameter, on first confidential information; generating test information, by performing the encoding processing using the encoding parameter, on second confidential information; and matching the template information with the test information.

A recording medium according to an example aspect of this disclosure is a recording medium on which a computer program that allows a computer to execute an information processing method is recorded, the information processing method including: storing, in a storage unit, template information generated by performing an encoding processing using an encoding parameter, on first confidential information; generating test information, by performing the encoding processing using the encoding parameter, on second confidential information; and matching the template information with the test information.

### BRIEF DESCRIPTION OF DRAWINGS

FIG. 1 is a block diagram illustrating a configuration of an information processing system in a first example embodiment.

FIG. 2 is a conceptual diagram illustrating an information processing system in a second example embodiment.

FIG. 3 is a block diagram illustrating a configuration of an information processing system in the second example embodiment.

FIG. 4 is a diagram illustrating an outline of cancelable biometric authentication in the second example embodiment.

FIG. 5 is a diagram illustrating an outline of a rekey processing in the second example embodiment.

FIG. 6 is a flowchart illustrating a flow of a template information registration operation of the information processing system in the second exemplary example embodiment.

FIG. 7 is a flowchart illustrating a flow of a matching operation of the information processing system in the second example embodiment.

FIG. 8 is a flowchart illustrating a flow of a recovery operation of the information processing system in the second example embodiment.

FIG. 9 is a block diagram illustrating a configuration of an information processing system in a third example embodiment.

FIG. 10 is a flowchart illustrating a flow of a template information registration operation of the information processing system in the third example embodiment.

FIG. 11 is a flowchart illustrating a flow of a matching operation of the information processing system in the third example embodiment.

FIG. 12 is a flowchart illustrating a flow of a recovery operation of the information processing system in the third example embodiment.

FIG. 13 is a block diagram illustrating a configuration of an information processing system in a fourth example embodiment.

FIG. 14 is a flowchart illustrating a flow of a template information registration operation of the information processing system in the fourth example embodiment.

FIG. 15 is a flowchart illustrating a flow of a recovery operation of the information processing system in the fourth example embodiment.

FIG. 16 is a flowchart illustrating a flow of a template information registration operation of an information processing system in a fifth example embodiment.

FIG. 17 is a flowchart illustrating a flow of a matching operation of the information processing system in the fifth example embodiment.

### DESCRIPTION OF EXAMPLE EMBODIMENTS

Hereinafter, an information processing system, an information processing method, and a recording medium according to example embodiments will be described with reference to the drawings.

### 1: First Example Embodiment

First, an information processing system, an information processing method, and a recording medium according to a first example embodiment will be described. The following describes the information processing system, the information processing method, and the recording medium according to the first example embodiment, by using an information processing system 1 to which the information processing system, the information processing method, and the recording medium according to the first example embodiment are applied.

### [1-1: Configuration of Information Processing System 1]

FIG. 1 is a block diagram illustrating a configuration of the information processing system 1 in the first example embodiment. As illustrated in FIG. 1, the information processing system 1 includes a storage control unit 11, a generation unit 12, and a matching unit 13.

The storage control unit 11 stores, in a storage apparatus, template information generated by performing an encoding processing using an encoding parameter on first confidential information. The generation unit 12 generates test information by performing the encoding processing using the encoding parameter on second confidential information. The matching unit 13 matches the template information with the test information. The template information and the test information are generated by performing the same encoding processing by using the same encoding parameter. That is, the matching unit 13 matches pieces of information subjected to the encoding processing with each other.

### [1-2: Technical Effect of Information Processing System 1]

The information processing system 1 in the first example embodiment performs the encoding processing on the confidential information, stores and matches the encoded information. That is, the information processing system 1 in the first example embodiment does not store or match the confidential information in the clear, i.e., that is not encoded. Therefore, even an administrator/manager has less opportunities to be in contact with the confidential information in the clear. Furthermore, even in the event of information leakage, the leaked information is not the confidential information itself, and it is therefore possible to maintain confidentiality.

### 2: Second Example Embodiment

Next, an information processing system, an information processing method, and a recording medium according to a second example embodiment will be described. The following describes the information processing system, the information processing method, and the recording medium according to the second example embodiment, by using an information processing system 2 to which the information processing system, the information processing method, and the recording medium according to the second example embodiment are applied.

### [2-1: Overall Configuration of Information Processing System 2]

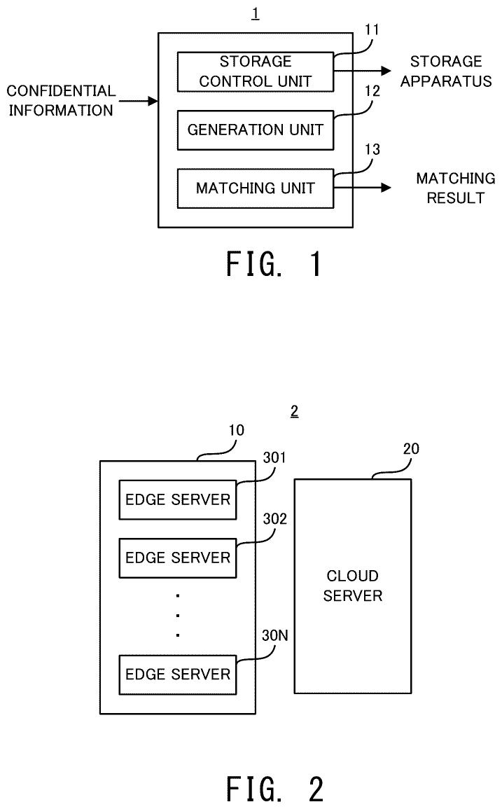

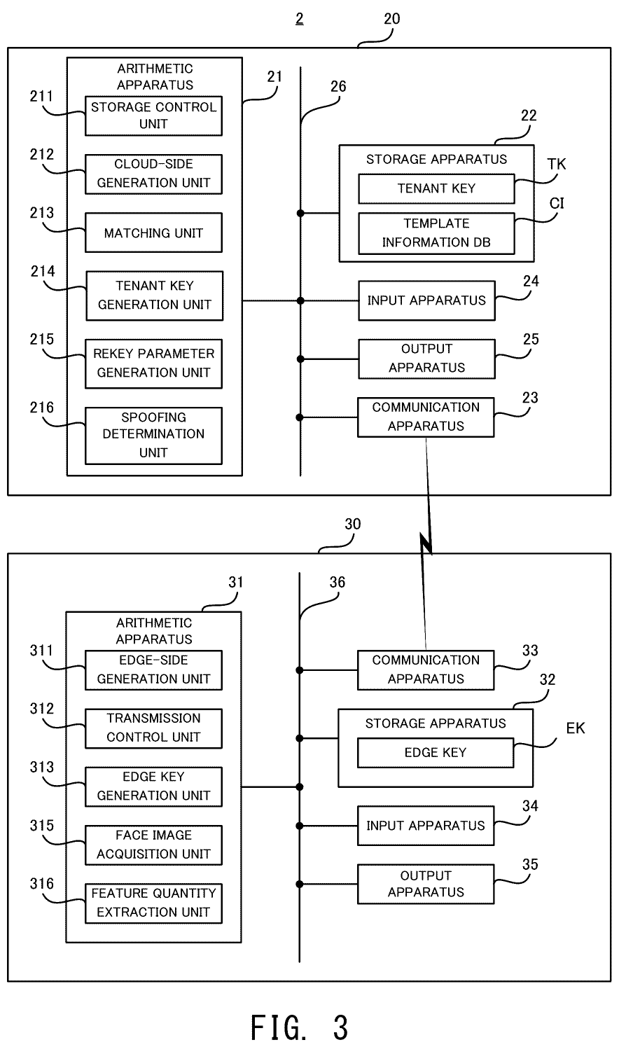

FIG. 2 is a conceptual diagram illustrating the information processing system 2 in the second example embodiment. As illustrated in FIG. 2, the information processing system 2 includes a tenant 10 and a cloud server 20. The tenant 10 may include one or more edge servers 301, 302, . . . , and 30N. When they are not distinguished, each of the edge servers 301, 302, . . . , and 30N are described as an edge server 30. The edge server 30 may be a part of the tenant 10, and the edge server 30 may be provided for each of a plurality of entrance gates provided in the tenant 10, for example. Furthermore, the edge server 30 may be provided in a retail store serving as the tenant 10, for example, and may be used as a terminal of facial recognition payment. Alternatively, the edge server 30 may be provided at a boarding gate at an airport. The edge server 30 may also be used as a face recognition check-in terminal at an airport.

The tenant 10 may be a unit by which the confidential information is shared. For example, the tenant 10 may be a unit of a store or a building, or may be a unit of a company or the like. The information processing system 2 may include one or more tenants 10 and one cloud server 20.

A server provided at headquarters of a retail store may be referred to as a tenant server. In a case where the information system 2 is applied to an airport, the tenant server may be provided at headquarter of an airline. The tenant server may be used as the cloud server 20.

The following describes a case of performing a biometric authentication processing for matching biometric information in the information processing system 2. The biometric authentication processing may include face recognition using a face image, iris recognition using an iris image, fingerprint recognition using a fingerprint image, palmprint recognition using a palmprint image, vein recognition using a vein image of a palm or the like, and otoacoustic authentication using a sound reflected from earholes (ear canal), and the like, but hereinafter described will be a case of the face recognition using a face image.

### [2-2-1: Configuration of Cloud Server 20]

FIG. 3 is a block diagram illustrating the information processing system 2 in the second example embodiment. With reference to FIG. 3, first, a configuration of the cloud server 20 included in the information processing system 2 will be described.

As illustrated in FIG. 3, the cloud server 20 includes an arithmetic apparatus 21 and a storage apparatus 22. Furthermore, the cloud server 20 may include a communication apparatus 23, an input apparatus 24, and an output apparatus 25. The cloud server 20, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the cloud server 20 (e.g., the input apparatus 24 described later). The arithmetic apparatus 21 may acquire (i.e., download or read) a computer program from a not-illustrated apparatus disposed outside the cloud server 20, through the communication apparatus 23 (or another communication apparatus). The arithmetic apparatus 21 executes the read computer program. Consequently, a logical functional block for performing an operation to be performed by the cloud server 20 is realized or implemented in the arithmetic apparatus 21. That is, the arithmetic apparatus 21 is allowed to function as a controller for realizing or implementing the logical function block for performing an operation (in other words, a processing) to be performed by the cloud server 20.

FIG. 3 illustrates an example of the logical functional block realized or implemented in the arithmetic apparatus 21 to perform a biometric authentication operation. As illustrated in FIG. 3, a storage control unit 211 that is a specific example of the “storage control unit”, a cloud-side generation unit 212 that is a specific example of the “generation unit”, a matching unit 213 that is a specific example of the “matching unit”, a tenant key generation unit 214 that is a specific example of the “second encoding parameter generation unit”, a rekey parameter generation unit 215, and a spoofing determination unit 216 are realized or implemented in the arithmetic apparatus 21.

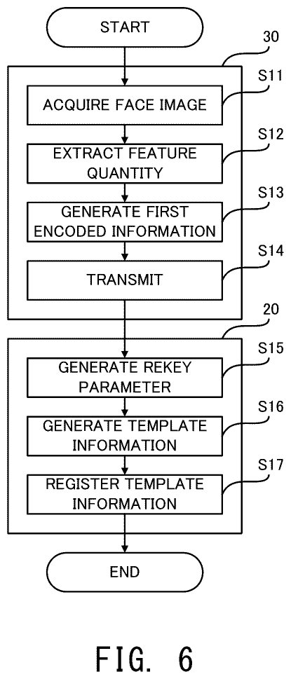

Details of operation of each of the storage control unit 211, the cloud-side generation unit 212, the matching unit 213, the tenant key generation unit 214, the rekey parameter generation unit 215, and the spoofing determination unit 216 will be described later with reference to FIG. 6 to FIG. 8. The arithmetic apparatus 21, however, may not include at least one of the tenant key generation unit 214, the rekey parameter generation unit 215, and the spoofing determination unit 216.

The tenant key generation unit 214 generates a tenant key TK serving as a second encoding parameter. The tenant key generation unit 214 generates the tenant key TK for each tenant 10. The tenant key generation unit 214 may generate the tenant key TK at any timing. The tenant key generation unit 214 may generate the tenant key TK in each predetermined period, for example. The tenant key generation unit 214 may store the generated tenant key TK in the storage apparatus 22, for example.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the cloud server 20 for a long time. The storage apparatus 22 may include a at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include anon-transitory recording medium.

The storage apparatus 22 may store the tenant key TK and a database (DB) of template information CI in which the template information CI is registered. The storage apparatus 22, however, may not store at least one of the tenant key TK and the DB of the template information CI.

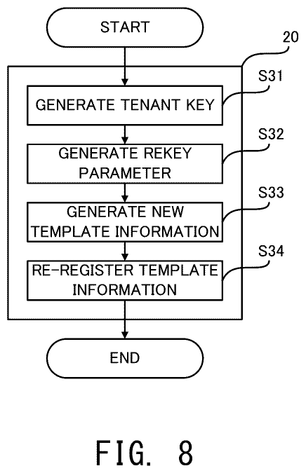

The storage apparatus 22 may perform a template information CI registration operation under the control of the storage control unit 211. Details of the template information CI registration operation under the control of the storage control unit 211 will be described later with reference to FIG. 6 and FIG. 8. The storage apparatus 22, however, may not perform the template information CI registration operation under the control of the storage control unit 211.

The communication apparatus 23 is configured to communicate with an apparatus external to the cloud server 20 through a not-illustrated communication network.

The input apparatus 24 is an apparatus that receives an input of information to the cloud server 20 from an outside of the cloud server 20. For example, the input apparatus 24 may include an operating apparatus (e.g., at least one of a keyboard, a mouse, and a touch panel) that is operable by an operator of the cloud server 20. For example, the input apparatus 24 may include a reading apparatus that is configured to read information recorded as data on a recording medium that is externally attachable to the cloud server 20.

The output apparatus 25 is an apparatus that outputs information to the outside of the cloud server 20. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-2-2: Configuration of Edge Server 30]

Next, a configuration of the edge server 30 included in the information processing system 2 in the second example embodiment will be described with reference to FIG. 3.

As illustrated in FIG. 3, the edge server 30 includes an arithmetic apparatus 31 and a storage apparatus 32. The edge server 30 may further include a communication apparatus 33, an input apparatus 34, and an output apparatus 35. The edge server 30, however, may not include at least one of the communication apparatus 33, the input apparatus 34, and the output apparatus 35. The arithmetic apparatus 31, the storage apparatus 32, the communication apparatus 33, the input apparatus 34, and the output apparatus 35 may be connected through a data bus 36.

The arithmetic apparatus 31 includes at least one of a CPU (Central Processing Unit), a GPU (Graphics Processing Unit), and a FPGA (Field Programmable Gate Array), for example. The arithmetic apparatus 31 reads a computer program. For example, the arithmetic apparatus 31 may read a computer program stored in the storage apparatus 32. For example, the arithmetic apparatus 31 may read a computer program stored by a computer-readable and non-transitory recording medium, by using a not-illustrated recording medium reading apparatus provided in the edge server 30 (e.g., the input apparatus 34 described later). The arithmetic apparatus 31 may acquire (i.e., download or read) a computer program from a not-illustrated apparatus disposed outside the edge server 30, through the communication apparatus 33 (or another communication apparatus). The arithmetic apparatus 31 executes the read computer program. Consequently, a logical functional block for performing an operation to be performed by the edge server 30 is realized or implemented in the arithmetic apparatus 31. That is, the arithmetic apparatus 31 is allowed to function as a controller for realizing or implementing the logical functional block for performing an operation (in other words, a processing) to be performed by the edge server 30.

FIG. 3 illustrates an example of the logical functional block realized or implemented in the arithmetic apparatus 31 to perform the biometric authentication operation. As illustrated in FIG. 3, an edge-side generation unit 311 that is a specific example of the “edge-side generation unit”, a transmission control unit 312 that is a specific example of the “transmission unit”, an edge key generation unit 313 that is a specific example of the “first encoding parameter generation unit”, a face image acquisition unit 315, and a feature quantity extraction unit 316 are realized or implemented in the arithmetic apparatus 31.

Details of operation of each of the edge-side generation unit 311, the transmission control unit 312, the edge key generation unit 313, the face image acquisition unit 315, and the feature quantity extraction unit 316 will be described later with reference to FIG. 6 to FIG. 8. The arithmetic apparatus 31, however, may not include at least one of the edge key generation unit 313, the face image acquisition unit 315, and the feature quantity extraction unit 316, so long as the arithmetic apparatus 31 is allowed to acquire a feature quantity of a living body.

The edge key generation unit 313 generates an edge key EK serving as a first encoding parameter. The edge key generation unit 313 may generate the edge key EK at any timing. The edge key generation unit 313 may generate the edge key EK in each predetermined period, for example. The edge server 30 may transmit the edge key EK to the cloud server 20 in a case where the edge key generation unit 313 generates a new edge key EK. When receiving first encoded information or second encoded information from the edge server 30, the cloud server 20 knows the edge key EK used to generate the first encoded information or the second encoded information.

The storage apparatus 32 is configured to store desired data. For example, the storage apparatus 22 may temporarily store a computer program to be executed by the arithmetic apparatus 31. The storage apparatus 32 may temporarily store data that are temporarily used by the arithmetic apparatus 31 when the arithmetic apparatus 31 executes the computer program. The storage apparatus 32 may store data that are stored by the edge server 30 for a long time. The storage apparatus 32 may include a at least one of a RAM (Random Access Memory), a ROM (Read Only Memory), a hard disk apparatus, a magneto-optical disk apparatus, a SSD (Solid State Drive), and a disk array apparatus. That is, the storage apparatus 32 may include anon-transitory recording medium.

The storage apparatus 32 may store the edge key EK serving as the first encoding parameter generated by the edge key generation unit 313. The storage apparatus 22, however, may not store the edge key EK. For example, the edge key EK may not be generated nor stored for each operation of generating third confidential information or fourth confidential information of the edge-side generation unit 311. In this instance, the edge server 30 may transmit, to the cloud server 20, the edge key EK used to generate the third confidential information or the fourth confidential information, together with the third confidential information or the fourth confidential information generated by the edge-side generation unit 311.

The communication apparatus 33 is configured to communicate with an apparatus external to the edge server 30 through a not-illustrated communication network. The communication apparatus 33 may transmit the first encoded information, the second encoded information, and the edge key EK, under the control of the transmission control unit 312.

The input apparatus 34 is an apparatus that receives an input of information to the edge server 30 from the outside of the edge server 30. Furthermore, the output apparatus 35 is an apparatus that outputs information to the outside of the edge server 30.

### [2-3: Outline of Cancelable Biometric Authentication]

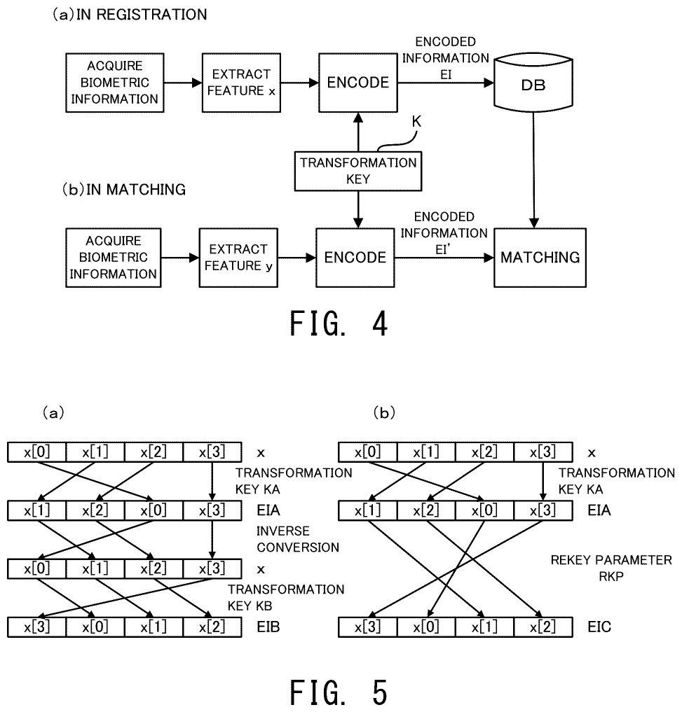

Next, with reference to FIG. 4, an outline of cancelable biometric authentication will be described.

In biometric authentication, biometric information on a target person for authentication (target person), such as a face image, an iris image, a fingerprint image, and a vein image, are registered in advance, and authentication is determined, on the basis of a comparison result with biometric information on the target person, which is inputted in the authentication. The biometric information, however, is said to be unchangeable throughout a lifetime, and even if the biometric information is leaked, it cannot be changed like a password. Therefore, once it is leaked, it cannot be used again for the authentication, which is problematic. In addition to a problem about personal information on the living body related to the leaked biometric information, there is a problem of compromising the security of an authentication system using the biometric information on the living body related to the leaked biometric information. To address such a problem, for the purpose of protecting the biometric information on the target person, a technique/method referred to as “cancelable biometric authentication” is used in the present example embodiment, wherein authentication is performed by using registered information in which the biometric information is concealed, and in a case where the registered information is leaked, the leaked registered information can be invalidated.

### [2-3-1: Flow of Registration of Biometric Information in Cancelable Biometric Authentication]

FIG. 4 is a diagram illustrating an outline of cancelable biometric authentication, and FIG. 4(a) is a diagram illustrating an outline of a flow in information registration of the cancelable biometric authentication.

In the information registration of the cancelable biometric authentication, first, the biometric information is acquired, and a feature quantity x is extracted from the acquired biometric information. For example, the feature quantity x that is a vector may be extracted from the biometric information. The feature quantity x may be an example of the third confidential information. Subsequently, by performing transformation using a transformation key K that is, for example, a vector, serving as an encoding parameter, the feature quantity x that is a vector is encoded to generate encoded information EI that is a vector. Hereafter, in some cases, the feature quantity x that is a vector is simply described as a “feature quantity x”, the transformation key K that is a vector is simply described as a “transformation key K”, the encoded information EI that is a vector is simply described as “coded information EI”. The transformation key K may be a randomly generated vector value. The encoded information EI is a piece of the registered information used in matching, and may be stored in a database or the like provided in the storage apparatus 22 or the like. The encoded information EI may be an example of the template information CI.

### [2-3-2: Flow of Matching of Biometric Information in Cancelable Biometric Authentication]

FIG. 4(b) is a diagram illustrating an outline of a flow in information matching of the cancelable biometric authentication.

In the information matching of the cancelable biometric authentication, first, the biometric information is acquired, and a feature quantity y is extracted from the acquired biometric information. For example, the feature quantity y that is a vector may be extracted from the biometric information. The feature quantity y may be an example of the fourth confidential information. Subsequently, by performing transformation using the transformation key K that is, for example, a vector, the feature quantity y that is a vector is encoded to generate encoded information EI′ that is a vector. The encoded information EI′ may be an example of the test information TI.

The encoded information EI′ is information in which the feature quantity y is transformed by the transformation using the same transformation key K as that of the encoded information EI. The encoded information EI′ is information to be matched with the encoded information EI. In the cancelable biometric authentication, it is possible to match the encoded information EI in which the feature quantity x is encoded with the encoded information EI′ in which the feature quantity y is encoded, while being encoded.

In the cancelable biometric authentication, the feature quantity is encoded by the transformation using the same transformation key K in the information registration and in the information matching. Thus, a degree of similarity between the feature quantity x and the feature quantity y is also stored after the encoding using the transformation key K.

For example, suppose that the feature quantity x and the feature quantity y are extracted from the face image of a same person serving as the biometric information, and that the feature quantity x is close to the feature quantity y. The encoded information EI is generated by transforming the feature quantity x, and the encoded information EI′ is generated by transforming the feature quantity y that is close to the feature quantity x. Accordingly, a degree of similarity between the encoded information EI and the encoded information EI′ corresponds to the degree of similarity between the feature quantity x and the feature quantity y, and the encoded information EI and the encoded information EI′ are pieces of information that are close to each other.

On the other hand, for example, suppose that transformation using a transformation key K1 and transformation using a transformation key K2 that is different from the transformation key K1 are performed on the same feature quantity x. By performing the transformation using the transformation key K1 on the feature quantity x, it is possible to generate encoded information EI1. In addition, by performing the transformation using the transformation key K2 on the feature quantity x, it is possible to generate encoded information EI2. Since the transformation key K1 is different from the transformation key K2, the generated encoded information EI1 is different from the encoded information EI2.

That is, when the encoded information EI2 is matched with the encoded information EI1, a degree of similarity between the encoded information Eli and the encoded information EI2 does not match the degree of similarity between the feature quantities x, even though the both pieces of encoded information are generated by transforming the same feature quantity x. As described above, in the cancelable biometric authentication, the encoded information Eli and the encoded information EI2 that are different, are generated by performing the transformation using the transformation key K1 and the transformation using the transformation key K2 that is different from the transformation key K1, on the same feature quantity x. By using such a property, it is possible to invalidate the registered information stored in the database or the like, by changing the transformation key K in the cancelable biometric authentication. Furthermore, in the cancelable biometric authentication, the encoded information EI and the encoded information EI′ are used in the matching, and the feature quantity x, the feature quantity y, and the transformation key K are not directly used.

In this way, in the cancelable biometric authentication, it is possible to manage and match the biometric information, which is the confidential information, while being encoded. In addition, in the cancelable biometric authentication, even when at least one of the encoded information obtained by encoding the confidential information and the encoding parameter used in the encoding processing, is leaked, it is possible to change the information used in the biometric authentication as many times as necessary so long as the encoding parameter is exchanged.

### [2-4: Outline of Rekey Processing]

Referring now to FIG. 5, an outline of a rekey processing will be described, with reference to a case where a transformation key KA that is an encoding parameter, is a replacement key for replacing the order of elements of respective dimensions included in the feature quantity x that is a vector.

In FIG. 5, a case where the feature quantity x is a dataset of four dimensions (the number of dimensions is 4) will be described. Furthermore, suppose that, in the transformation key KA, parameters for rearranging a zero-dimension element of the feature quantity x (x[0]) in a second dimension, rearranging a first-dimension element of the feature quantity x (x[1]) in a zero dimension, rearranging a second-dimension element of the feature quantity x (x[2]) in a first dimension, and rearranging a third-dimension element of the feature quantity x (x[3]) in a third dimension, are defined, for example.

The edge-side generation unit 311 may perform the encoding processing on the feature quantity x by using the transformation key KA and may generate encoded information EIA, as illustrated in first to second levels from the top of FIG. 5(a). On the other hand, at least one of the storage control unit 211 and the cloud-side generation unit 212 may perform the encoding processing on the feature quantity x by using a transformation key KB that is different from the transformation key KA, thereby to generate encoded information EIB illustrated in a fourth level from the top of FIG. 5(a). For example, suppose that, in the transformation key KB, parameters for rearranging the zero-dimension element of the feature quantity x (x[0]) in the first dimension, rearranging the first-dimension element of the feature quantity x (x[1]) in the first dimension, rearranging the second-dimension element of the feature quantity x (x[2]) in the third dimension, and rearranging the third-dimension element of the feature quantity x (x[3]) in the zero dimension, are defined, for example.

In this case, at least one of the storage control unit 211 and the cloud-side generation unit 212 (1) may perform inverse transformation using the transformation key KA on the encoded information EIA to decode it to the feature quantity x, as illustrated in the second to third levels from the top of FIG. 5(a), then (2) may perform transformation using the transformation key KB on the decoded feature quantity x, thereby generate the encoded information EIB, as illustrated in third to fourth levels from the top of FIG. 5(a).

Alternatively, at least one of the storage control unit 211 and the cloud-side generation unit 212 may transform the encoded information EIA without inversely transforming the encoded information EIA to the feature quantity x. Specifically, the rekey parameter generation unit 215 may generate a rekey parameter RKP by using the transformation key KA and the transformation key KB. The rekey parameter RKP may be a parameter that enables a processing corresponding to decoding the encoded information EIA and transforming it by using the transformation key KB.

As illustrated in second to third levels from the top of FIG. 5(b), at least one of the storage control unit 211 and the cloud-side generation unit 212 generates encoded information EIC by transforming the encoded information EIA by using the rekey parameter RKP. As illustrated in FIG. 5, the order of arranging elements included in the encoded information EIC is the same as that of the elements included in the encoded information EIB. That is, at least one of the storage control unit 211 and the cloud-side generation unit 212 is capable of generating a dataset corresponding to the encoded information EIB in which the feature quantity x is encrypted by using the transformed key KB, by transforming the encoded information EIA using the rekey parameter RKP. As described above, in the second example embodiment, it is possible to generate the dataset corresponding to the encoded information EIB without decoding the encoded information EIA to the feature quantity x in the cloud server 20. That is, there is no risk that the feature quantity x in the clear, i.e., that is not encoded, is leaked.

When the cloud server 20 receives, from the edge server 30, the encoded information EK subjected to the encoding processing using the edge key EK, the rekey parameter generation unit 215 may generate the rekey parameter RKP on the basis of the tenant key TK stored in the storage apparatus 22 and the edge key EK received from the edge server 30. At least one of the storage control unit 211 and the cloud-side generation unit 212 is allowed to perform the rekey processing on the received encoded information EIA, by using the rekey parameter RKP.

As illustrated in the second to fourth levels from the top of FIG. 5(a), the order of arranging the elements of the encoded information EIB generated by using the transformation key KB for the feature quantity x, is different from that of the elements of the encoded information EIA generated by using the transformation key KA for the feature quantity x. Accordingly, in the rekey processing, it is possible to invalidate the encoded information EIA, by transforming the encoded information KA generated by using the transformation key KA for the feature quantity x, to the encoded information EIC corresponding to the encoded information EIB generated by using the transformation key KB for the feature quantity x.

Furthermore, in a case where at least one of the tenant key TK and the template information CI is leaked, the rekey parameter generation unit 215 may generate the rekey parameter RKP on the basis of a new tenant key TK generated by the tenant key generation unit 214 and an old tenant key TK stored in the storage apparatus 22. The storage control unit 211 may perform the rekey processing on the template information CI stored in the storage apparatus 22 by using the rekey parameter RKP, and may update the template information CI.

Furthermore, at a timing when at least one of the edge key EK and the maintenance key TK is updated, such as periodic maintenance, a processing of generating the rekey parameter RKP by the rekey parameter generation unit 215 and a processing of updating the template information CI by the storage control unit 211 may be performed.

The above exemplifies and describes that a transformation processing using the replacement key as the transformation key K is applied as the rekey processing, but another transformation processing may be applied as the rekey processing applied to the second example embodiment. The applicable transformation processing may be, for example, a transformation processing of dividing an image into blocks and shuffling the positions, which is used in the matching of images (exact match). In the case of matching using the feature quantity and a feature vector, such as fingerprint matching, it may be ae geometric transformation processing of minutiae in which an entire image is projected onto a distorted plane where a position and a direction are maintained. In the case of matching using Hamming distance like iris matching, a transformation processing in which the Hamming distance is invariant, may be performed. In addition, in a case where a matching target is an image, the transformation key K may be a shuffle key that shuffles the positions of the image divided into blocks.

Hereinafter, the encoding parameter may be a transformation key used for an information transformation processing in the cancelable biometric authentication, and the encoding processing may be an information transformation processing in the cancelable biometric authentication. In addition, the information transformation processing in the cancelable biometric authentication may be referred to as a cancelable transformation processing in some cases.

### [2-5: Template Information CI Registration Operation Performed By Information Processing System 2]

Next, with reference to FIG. 6, a template information CI registration operation performed by the information processing system 2 in the second example embodiment will be described. FIG. 6 is a diagram illustrating a flow of the template information CI registration operation performed by the information processing system 2 in the second example embodiment.

As illustrated in FIG. 6, the face image acquisition unit 315 acquires the face image of an individual as the biometric information (step S11). The face image acquisition unit 315 may be, for example, an imaging apparatus that is configured to capture the face image. In addition, the face image acquisition unit 315 may be a video imaging apparatus that is configured to continuously acquire a plurality of face images. The face image acquisition unit 315 may also acquire the face image through the input apparatus 34. For example, the face image acquisition unit 315 may be a mechanism that acquires, from a mobile terminal such as a smartphone, the face image stored in the mobile terminal by a radio technique such as Bluetooth.

The feature quantity extraction unit 316 extracts the feature quantity of the face image (step S12). This feature quantity may be an example of the third confidential information.

The edge-side generation unit 311 generates the first encoded information, by performing a first encoding processing using the edge key EK serving as the first encoding parameter, on the feature quantity (step S13). The first encoding processing may include the cancelable transformation processing.

The transmission control unit 312 transmits the first encoded information to the cloud server 20 as the first confidential information (step S14).

The step S11 to the step S14 described above are performed by the edge server 30. Furthermore, a step S15 to a step S17 described below are performed by the cloud server 20.

The rekey parameter generation unit 215 generates the rekey parameter RKP from the edge key EK and the tenant key TK serving as the second encoding parameter that is different from the first encoding parameter (step S15).

The storage control unit 211 generates the template information CI, by performing a second encoding processing using the tenant key TK, on the first encoded information transmitted from the edge server 30 as the first confidential information (step S16). The second encoding processing may include an encoding processing using the tenant key TK and the edge key EK. The second encoding processing may include an encoding processing using the edge key EK in addition to the tenant key TK. The second encoding processing may be the rekey processing including the cancelable transformation processing. The storage control unit 211 may perform the cancelable transformation processing using the edge key EK and the tenant key TK. The storage control unit 211 may perform the cancelable transformation processing using the rekey parameter RKP. That is, the storage control unit 211 does not need to decode the first confidential information that is encoded by using the edge key EK, to be in the clear.

The storage control unit 211 registers the generated template information CI, in the DB of the template information CI built in the storage apparatus 22 (step S17).

[2-6: Test information TI Matching Operation Performed By Information Processing System 2]

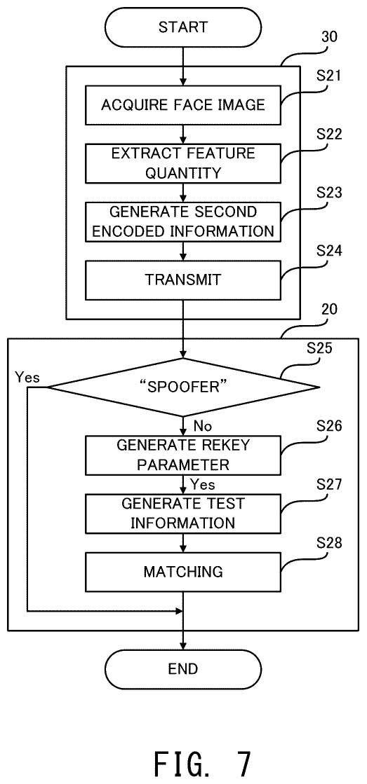

Next, with reference to FIG. 7, a test information TI matching operation performed by the information processing system 2 in the second example embodiment will be described. FIG. 7 is a diagram illustrating a flow of the test information TI matching operation performed by the information processing system 2 in the second example embodiment.

As illustrated in FIG. 7, the face image acquisition unit 315 acquires the face image of an individual as the biometric information (step S21). The feature quantity extraction unit 316 extracts the feature quantity of the face image (step S22). This feature quantity may be an example of the fourth confidential information.

The edge-side generation unit 311 generates the second encoded information, by performing the first encoding processing using the edge key EK serving as the first encoding parameter, on the feature quantity (step S23). The first encoding processing may be the cancelable transformation processing.

The transmission control unit 312 transmits the second encoded information to the cloud server 20 as the second confidential information (step S24).

The step S21 to the step S24 described above are performed by the edge server 30. Furthermore, a step S25 to a step S27 described below are performed by the cloud server 20.

The spoofing determination unit 216 determines whether or not the target person is a “spoofer” from a plurality of pieces of second confidential information corresponding to the target person (step S25). Here, a case where the target person is a “spoofer” may be a case where the spoofing determination unit 216 is allowed to determine that the plurality of pieces of second confidential information corresponding to the target person are not derived from a particular living individual. Since the plurality of pieces of second confidential information corresponding to the target person are subjected to the cancelable transformation processing by using the same encoding parameter, the plurality of pieces of second confidential information may be used for the processing of matching or the like while still being encoded. That is, the spoofing determination unit 216 may determine whether or not the target person is a “spoofer” without decoding the confidential information to be in the clear. In addition, the spoofing determination unit 216 is allowed to determine whether or not the target person is a “spoofer” without the cancelable transformation processing by the tenant key TK. For example, when the face image acquisition unit 315 acquires a video, an operation instruction is given to the target person, and when determining that the target person is performing an operation corresponding to the operation instruction, the spoofing determination unit 216 may determine that the target person is not a “spoofer”. In the second example embodiment, an arbitrary technique may be applied to the “spoofing” determination.

When the target person is not a “spoofer” (the step S25: No), the rekey parameter generation unit 215 generates the rekey parameter RKP from the edge key EK and the tenant key TK (step S26).

The cloud-side generation unit 212 generates the test information TI, by performing the second encoding processing using the tenant key TK serving as the second encoding parameter that is different from the first encoding parameter, on the second encoded information transmitted from the edge server 30 as the second confidential information (step S27). The second encoding processing may be the rekey processing including the cancelable transformation processing. The cloud-side generation unit 212 may perform the cancelable transformation processing using the edge key EK and the tenant key TK. The cloud-side generation unit 212 may perform the cancelable transformation processing using the rekey parameter RKP. That is, the cloud-side generation unit 212 does not need to decode the second confidential information that is encoded by using the edge key EK, to be in the clear.

The matching unit 213 matches the template information CI with the test information TI (step S28). The matching unit 213 may determine whether or not the test information TI and any of a plurality of pieces of template information CI registered in the storage apparatus 22 are similar to a predetermined or more extent. That is, the information processing system 2 may perform one-to-N matching.

The matching unit 213 may transmit a matching result to the edge server 30 through the communication apparatus 23 and the communication apparatus 33. The edge server 30 may perform an operation corresponding to the received matching result. For example, in a case where the edge server 30 is associated with a gate of the tenant 10, an operation of opening the gate may be performed when the matching result is OK, and an operation of not opening the gate may be performed when the matching result is NG, or a similar operation may be performed.

When the target person is not a “spoofer” (the step S25: No), the test information TI matching operation is ended.

In the above case, when the target person is not a “spoofer”, the matching operation for the target person is performed. That is, the cloud server 20 performs the matching operation after the operation of “spoofing” determination, but it is not limited to this example. For example, the cloud server 20 may perform the operation of “spoofing” determination and the matching operation in parallel, and when both the operations are OK, the edge server 30 may open the gate of the tenant 10.

In the above, the “spoofing” determination is made on the basis of the operation by the target person, but it is not limited to this example. The operation of “spoofing” determination may employ a technique/method using a stereoscopic 3D information on a face. For example, an image captured using infrared rays, a depth image, a thermal image, or the like may be used, or a plurality of images in different light irradiation conditions by a light-emitting mechanism may be used. The plurality of images in different light irradiation conditions by the light-emitting mechanism may be acquired by performing imaging with a camera mounted on a portable device while changing a color, a layout, or the like of a display of the portable device and using a screen flash multiple times, for example.

### [2-7: Recovery Operations Performed By Information Processing System 2]

Next, with reference to FIG. 8, a recovery operation performed by the information processing system 2 in the second example embodiment will be described. FIG. 8 is a flowchart illustrating a flow of the recovery operation performed by the information processing system 2 in the second exemplary example embodiment. The information processing system 2 may perform the recovery operation in a case where at least one of the tenant key TK and the template information CI is leaked.

The tenant key generation unit 214 generates anew tenant key TK (step S31). The rekey parameter generation unit 215 generates the rekey parameter RKP from the old tenant key TK and the new tenant key TK (step S32). The rekey parameter generation unit 215 may read out the old tenant key TK, for example, from the storage apparatus 22, and may generate the rekey parameter RKP by using the read old tenant key TK together with the new tenant key TK generated in the step S31. The tenant key generation unit 214 may discard the old tenant key TK after the generation of the rekey parameter RKP, and may store the generated tenant key TK in the storage apparatus 22, for example.

The storage control unit 211 generates new template information CI, by performing the rekey processing using the rekey parameter RKP on old template information CI (step S33). The storage control unit 211 stores the generated template information CI in the storage apparatus 22, for example, and re-registers the new template information CI (step S34). The storage control unit 211 discards the old template information CI. The storage control unit 211 may discard the old template information CI stored in the storage apparatus 22, for example.

As described above, in the recovery operation when at least one of the tenant key TK and the template information CI is leaked, the processing in the edge server 30 is not performed.

On the other hand, in the recovery operation when the edge key EK is leaked, it is sufficient that the edge key EK is exchanged. As a consequence, the processing in the cloud server 20 is not performed.

The encoding processing by the generation unit 311 may not be the cancelable transformation processing, and may be, for example, an encryption processing using a common-key system, a public-key system, or the like.

Furthermore, the second example embodiment exemplifies and describes a case where, in the edge server 30, the face image is acquired, the feature quantity is extracted and encoded, and the first confidential information or the second confidential information is transmitted to the cloud server 20. For example, the processing in the edge server 30 may be realized in a portable apparatus carried by the target person, such as a smartphone. For example, a dedicated application for the biometric authentication may be installed on a terminal apparatus, such as a smartphone, carried by the target person. This dedicated application may support a set of desired operations, such as capturing the face image, extracting the feature quantity, the encoding processing, transmitting the first or second confidential information to the cloud server 20, and receiving an authentication result from the cloud server 20. This dedicated application may be acquired through the Internet.

Next, a case where the cloud server 20 receives the first encoded information and the edge key EK at a timing when an update processing of processing the tenant key TK and an update processing of updating the template information CI are performed, will be described.

When transmitting the first encoded information and the edge key EK, the edge server 30 may transmit time information on the transmission. In a case where the time information indicates a time before the completion of the update processing, the rekey parameter generation unit 215 may generate the rekey parameter RKP by using the old tenant key TK, the cloud-side generation unit 212 may generate the test information TI by using the rekey parameter RKP, and the matching unit 213 may match the test information TI with the old template information CI.

On the other hand, in a case where the time information indicates a time after the completion of the update processing, the rekey parameter generation unit 215 may generate the rekey parameter RKP by using the new tenant key TK, the cloud-side generation unit 212 may generate the test information TI by using the rekey parameter RKP, and the matching unit 213 may match the test information TI with the new template information CI.

Specifically, a case where the cloud server 20 determines to update the tenant key TK at a time of 10:00:10 and completes updating the tenant key TK and the template information CI at a time of 10:01:30 is exemplified and described. In a case where the time information received by the cloud server 20 indicates between the time of 10:00:10 and the time of 10:01:30, the rekey parameter generation unit 215 generates the rekey parameter RKP by using the old tenant key TK, and the matching unit 213 performs the matching using the old template information CI. On the other hand, in a case where the time information received by the cloud server 20 indicates a time of 10:01:31 or later, the rekey parameter generation unit 215 generates the rekey parameter RKP by using the new tenant key TK, and the matching unit 213 performs the matching using the new template information CI.

Alternatively, in a case where the cloud server 20 receives the first encoded information and the edge key EK at the timing when the update processing of updating the tenant key TK and the update processing of updating the template information CI are performed, the matching operation in the cloud server 20 may be stopped. In the case of the above example, in a case where the time information received by the cloud server 20 indicates between the time of 10:00:10 and the time of 10:01:30, the cloud server 20 may transmit, to the edge server 30, an indication that the matching operation is not allowed. The cloud server 20 may transmit, to the edge server 30, different information from that in a case where the matching result is NG. The cloud server 20 may transmit, to the edge server 30, a request to retransmit the information that the matching operation is not allowed, the first encoded information, and the edge key EK.

### [2-8: Technical Effect of Information Processing System 2]

According to the information processing system 2 in the second example embodiment, it is possible to match pieces of information encoded by using the tenant key TK that is a different encoding parameter from the edge key EK used in the edge server 30. Furthermore, according to the information processing system 2 in the second example embodiment, the cloud server 20 stores the information encoded by using an encoding parameter that is different from the encoding parameter used in the edge server 30. Therefore, even in the event of information leakage in the edge server 30 and an information transmission/reception path, or the like, for example, the information stored in the cloud server 20 is maintained in a safe state. Furthermore, since the cloud server 20 encodes the confidential information by using the leaky parameter RKP generated from both the edge key EK and the tenant key TK, it is possible to maintain the confidentiality without decoding the confidential information to be in the clear.

Furthermore, for example, even when at least one of the tenant key TK and the template information CI is leaked in the cloud server 20, since the cloud server 20 is allowed to generate the tenant key TK serving as the second encoding parameter, it is sufficient to take measures of exchanging the tenant key TK and performing the rekey processing in the cloud server 20. Since it is sufficient to exchange the tenant key TK and perform the rekey processing in the cloud server 20, an effort/labor for taking measures is relatively small. Furthermore, even in the event of information leakage in the edge server 30 and an information transmission/reception path, or the like, for example, it is possible to newly generate and exchange the edge key EK serving as the first encoding parameter.

In addition, in a case where the transformation processing using the edge key EK is the cancelable transformation processing, it is possible to perform the “spoofing” determination, while the confidential information remains the encoded information that is not in the clear.

### 3: Third Example Embodiment

Next, an information processing system, an information processing method, and a recording medium according to a third example embodiment will be described. The following describes the information processing system, the information processing method, and the recording medium according to the third example embodiment, by using an information processing system 3 to which the information processing system, the information processing method, and the recording medium according to the third example embodiment are applied.

The information processing system 3 to which the third example embodiment is applied, may be applied to a personal authentication operation when the target person makes payment in the tenant, for example. For example, when the target person takes an action required to make payment, such as paying for food and drinks and purchasing goods, in the tenant, the information processing system 3 may permit a facial recognition payment operation, such as payment from an account of the target person and payment by a credit card, in a case where the target person can be authenticated or his/her identity can be verified. A scene where the information processing system 3 is applied, however, is not limited to the scene exemplified here.

In addition, for example, when the target person enters the tenant, ID information on the target person may be acquired from a portable terminal equipped with a Bluetooth function (hereinafter referred to as a “BT terminal”), such as a smartphone, carried by the target person, and it may be confirmed before the authentication whether the template information CI corresponding to the ID information is registered in the DB of the edge server 30. In a case where the template information CI corresponding to the ID information is not registered in the DB of the edge server 30, it is possible to request the template information CI corresponding to the ID information from the cloud server 20, and to make the template information CI corresponding to the ID information available at the edge server 30 at the timing of authentication. Thus, the edge server 30 is capable of smoothly performing an authentication operation. That is, the information processing system 3 to which the third example embodiment is applied, may perform one-to-one matching.

The template information CI registered in the DB of the edge server 30 may remain registered in the DB of the edge server 30, for example, for a predetermined period such as one month, from a previous use. In this way, there is no need to request, from the cloud server 20 every time, the template information CI on the target person who visits many times the tenant where the edge server 30 is installed. Thus, even in the edge server 30 corresponding to the same tenant, the template information CI registered in the DB may be different for each edge server 30.

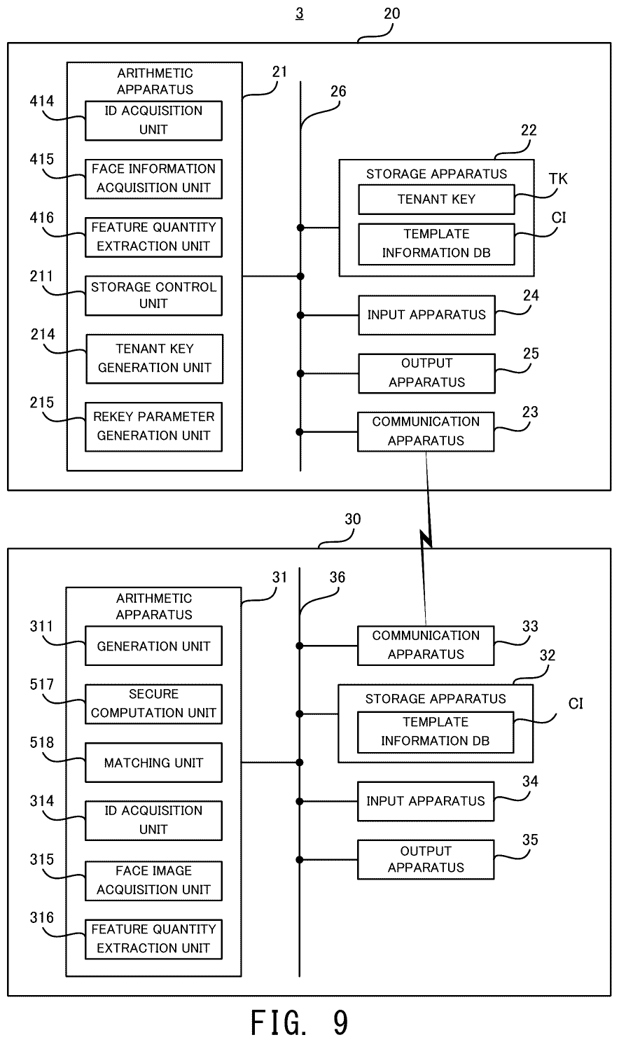

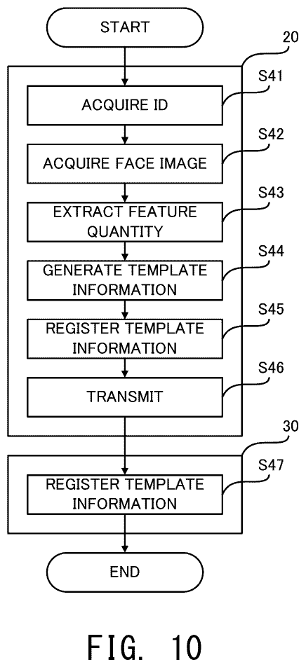

With reference to FIG. 9, a configuration of the information processing system 3 in the third example embodiment will be described. FIG. 9 is a block diagram illustrating the configuration of the information processing system 3 in the third example embodiment. In the following description, the already described components carry the same reference numerals, and a detailed description thereof will be omitted.

### [3-1: Configuration of Cloud Server 20]

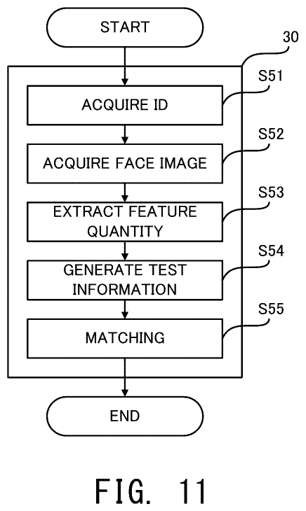

FIG. 9 illustrates an example of the logical functional block realized or implemented in the arithmetic apparatus 21 to perform the biometric authentication operation. As illustrated in FIG. 9, the storage control unit 211 that is a specific example of the “storage control unit”, the tenant key generation unit 214 that is a specific example of the “third encoding parameter generation unit”, the rekey parameter generation unit 215, an ID acquisition unit 414, a face image acquisition unit 415, and a feature quantity extraction unit 416 are realized or implemented in the arithmetic apparatus 21. Details of operation of each of the storage control unit 211, the tenant key generation unit 214, the ID acquisition unit 414, the face image acquisition unit 415, and the feature quantity extraction unit 416 will be described later with reference to FIG. 10 to FIG. 12. The arithmetic apparatus 21, however, may not include at least one of the tenant key generation unit 214, the ID acquisition unit 414, the rekey parameter generation unit 215, the face image acquisition unit 415, and the feature quantity extraction unit 416.

The tenant key generation unit 214 generates the tenant key TK serving as a third encoding parameter Even in the third example embodiment, the tenant key generation unit 214 generates the tenant key TK for each tenant. The tenant key generation unit 214 may generate the tenant key TK at any timing. The tenant key generation unit 214 may generate the tenant key TK in each predetermined period, for example. The cloud server 20 may transmit the tenant key TK to the edge server 30 in response to a request of the edge server 30, for example, at the start of a work on a day. The cloud server 20 transmits the tenant key TK of the tenant corresponding to the edge server 30. The cloud server 20 may also transmit the tenant key TK to the edge server 30 in a case where the tenant key generation unit 214 generates the new tenant key TK. The tenant key TK transmitted by the cloud server 20 may be the same as the tenant key TK used for the encoding processing of the template information CI in the DB of the template information CI registered in the storage apparatus 32 of the edge server 30.

### [3-2: Configuration of Edge Server 30]

FIG. 9 illustrates an example of the logical functional block realized or implemented in the arithmetic apparatus 31 to perform the biometric authentication operation. As illustrated in FIG. 9, the generation unit 311 that is a specific example of the “generation unit”, a secure computation unit 517 that is a specific example of the “secure computation unit”, a matching unit 518 that is a specific example of the “matching unit”, an ID acquisition unit 314, the face image acquisition unit 315, and the feature quantity extraction unit 316 are realized or implemented in the arithmetic apparatus 31.

Details of operation of each of the generation unit 311, the ID acquisition unit 314, the face image acquisition unit 315, the feature quantity extraction unit 316, the secure computation unit 517, and the matching unit 518 will be described later with reference to FIG. 10 to FIG. 12. The arithmetic apparatus 31, however, may not include at least one of the ID acquisition unit 314, the face image acquisition unit 315, the feature quantity extraction unit 316, the secure computation unit 517, and the matching unit 518.

The secure computation unit 517 performs secure computation while keeping information encrypted. The secure computation unit 517 is configured to process the encrypted information, without decrypting it to the original information. The secure computation unit 517 stores the tenant key TK serving as the third encoding parameter received from the cloud server 20, and performs the encoding processing using the tenant key TK. The secure computation unit 517 may receive the tenant key TK from the cloud server 20, for example, at the start of a work on a day. In addition, the secure computation unit 517 may receive the tenant key TK from the cloud server 20 in a case where the tenant key generation unit 214 generates the new tenant key TK.

In the third example embodiment, since the tenant key TK is stored in the secure computation unit 517, it cannot be seen from the outside. Even if the edge server 30 itself is physically stolen, the cloud server 20 regenerates the tenant key TK and invalidates the stolen tenant key TK, so that it is possible to maintain security.

In the third example embodiment, the target person may carry the BT terminal in the registration of the template information CI and in the matching of the test information TI. The BT terminal may store the ID information on the target person. That is, in the registration of the template information CI, the cloud server 20 may acquire face image of the target person, may acquire the ID information, and may register the ID information and information obtained by encoding the feature quantity of the face image that is the template information CI, in association with each other. Furthermore, in the matching of the test information TI, the cloud server 20 may acquire the ID information from the BT terminal, and may match the template information CI registered in association with the ID information, with the information obtained by encoding the feature quantity of the acquired face image that is the test information TI.

### [3-3: Template Information CI Registration Operation Performed By Information Processing System 3]

Next, with reference to FIG. 10, a template information CI registration operation performed by the information processing system 3 in the third example embodiment will be described. FIG. 10 is a flowchart illustrating a flow of the template information CI registration operation performed by the information processing system 3 in the third example embodiment.

As illustrated in FIG. 10, the ID acquisition unit 414 acquires the ID information on the target person from the BT terminal (step S41). Subsequently, the face image acquisition unit 415 acquires the face image of the individual as the biometric information (step S42). The feature quantity extraction unit 416 extracts the feature quantity of the face image (step S43). This feature quantity may be an example of the first confidential information. In addition to the ID information on the target person and the face image of the target person, the BT terminal may transmit information about the tenant frequently used by the target person, to the cloud server 20.

The storage control unit 211 generates the template information CI, by performing a third encoding processing using the tenant key TK serving as the third encoding parameter, on the feature quantity (step S44). The third encoding processing may include the cancelable transformation processing.

The storage control unit 211 registers the generated template information CI in the DB of the template information CI built in the storage apparatus 22 (step S45). The storage control unit 211 transmits the template information CI related to the edge server 30 that is a destination, out of the generated template information CI, to the edge server 30 through the communication apparatus 23 (step S46). The storage control unit 211 may transmit, to the edge server 30, the template information CI on the target person who visits many times the tenant where the edge server 30 is installed, on the basis of the information about the tenant frequently used by the target person, which is received from the BT terminal.

The step S41 to the step S46 described above are performed by the cloud server 20. Furthermore, a step S47 described below is performed by the edge server 30.

The edge server 30 registers the template information CI received through the communication apparatus 33, in the DB of the template information CI built in the storage apparatus 32 (step S47).

The DB of the template information CI for each tenant may be built in the storage apparatus 22. That is, the DB that registers therein the template information CI on the target person who uses a certain tenant, may be built in the storage apparatus 22 for each relevant tenant. Furthermore, the DB that registers therein the template information CI on the target person who often uses a location corresponding to the relevant edge server 30, may be built int the storage apparatus 32.

[3-4: Test information TI Matching Operation Performed By Information Processing System 3]

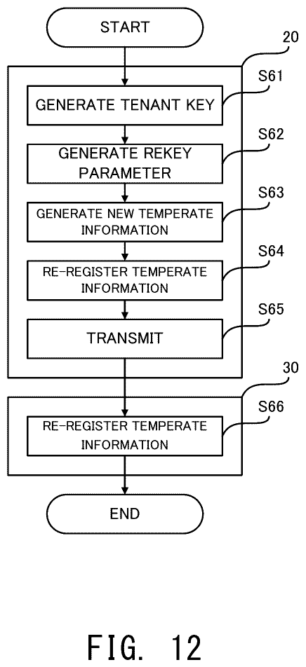

Next, with reference to FIG. 11, a test information TI matching operation performed by the information processing system 3 in the third example embodiment will be described. FIG. 11 is a diagram illustrating a flow of the test information TI matching operation performed by the information processing system 3 in the third example embodiment.

As illustrated in FIG. 11, the ID acquisition unit 314 acquires the ID information on the target person from the BT terminal (step S51). Subsequently, the face image acquisition unit 315 acquires the face image of the individual as the biometric information (step S52). The feature quantity extraction unit 316 extracts the feature quantity of the face image (step S53). This feature quantity may be an example of the second confidential information.

The generation unit 311 generates the test information TI, by performing the third encoding processing on the feature quantity, by using the secure computation unit 517 (step S54). In addition, before the step S54, the “spoofing” determination using the feature quantity in the clear, may be performed to determine whether or not to perform a processing after the step S54.

The matching unit 518 matches the template information CI with the test information TI (step S55). The edge server 30 may perform an operation corresponding to a matching result by the matching unit 518. For example, in a case where the edge server 30 is associated with a payment operation of the tenant 10, an operation of making payment may be performed when the matching result is OK, and an operation of not making payment may be performed when the matching result is NG, or a similar operation may be performed.

### [3-5: Recovery Operations Performed By Information Processing System 3]

Next, a recovery operation performed by the information processing system 3 in the third example embodiment will be described with reference to FIG. 12. FIG. 12 is a flowchart illustrating a flow of the recovery operation performed by the information processing system 3 in the third example embodiment. The information processing system 3 may perform the recovery operation in a case where at least one of the tenant key TK and the template information CI is leaked.

The tenant key generation unit 214 generates anew tenant key TK (step S61). The rekey parameter generation unit 215 generates the rekey parameter RKP from the old tenant key TK and the new tenant key TK (step S62). The rekey parameter generation unit 215 reads out the old tenant key TK from the storage apparatus 22, for example, and may generate the rekey parameter RKP by using the read old tenant key TK together with the new tenant key TK generated in the step S61. The tenant key generation unit 214 may discard the older tenant key TK after the generation of the rekey parameter RKP, and may store the generated tenant key TK in the storage apparatus 22, for example.

The storage control unit 211 generates new template information CI, by performing the rekey processing using the rekey parameter RKP, on old template information CI (step S63). The storage control unit 211 stores the generated template information CI in the storage apparatus 22, for example, and re-registers the new template information CI (step S64). The storage control unit 211 may discard the old template information CI. The storage control unit 211 may discard the old template information CI stored in the storage apparatus 22, for example.

Hereinafter, a step S65 to a step S66 are performed after the security of the edge server 30 is confirmed.

The storage control unit 211 transmits the generated template information CI to the edge server 30 through the communication apparatus 23 (step S65).

The step S61 to the step S65 described above are performed by the cloud server 20. A step S66 described below is performed by the edge server 30.

The edge server 30 registers the template information CI received through the communication apparatus 33, in the DB built in the storage apparatus 32 (step S66).

### [3-6: Technical Effect of Information Processing System 3]

According to the information processing system 3 in the third example embodiment, since the computation is performed while the information is encrypted, it is possible to prevent information leakage. Since the tenant key TK serving as the third encoding parameter received from the cloud server 20 is stored in the secure computation unit 517, it is not exposed other than the secure computation unit 517. In addition, since the template information CI and the test information TI that are encoded by using the tenant key TK also exist outside the secure computation unit 517, it is possible to maintain the security of the tenant key TK and the encoding processing. Furthermore, for example, in a case where a plurality of edge servers 30 are included in the same tenant, the plurality of edge servers 30 can share the DB of the template information CI, and it is thus possible to reduce an information holding load in the tenant. Furthermore, for example, even when at least one of the tenant key TK and the template information CI is leaked in the cloud server 20, since the tenant key generation unit 214 is allowed to generate the tenant key TK serving as the third encoding parameter, it is sufficient to take measures of exchanging the tenant key TK and performing the rekey processing in the cloud server 20. Since it is sufficient to exchange the tenant key TK and perform the rekey processing in the cloud server 20, an effort/labor for taking measures is relatively small.

### 4: Fourth Example Embodiment

Next, an information processing system, an information processing method, and a recording medium according to a fourth example embodiment will be described. The following describes the information processing system, the information processing method, and the recording medium according to the fourth example embodiment, by using an information processing system 4 to which the information processing system, the information processing method, and the recording medium according to the fourth example embodiment are applied.

The information processing system 4 to which the fourth example embodiment is applied, may be applied to the personal authentication operation when the target person makes payment in the tenant, for example, as in the information processing system 3 to which the third example embodiment is applied.

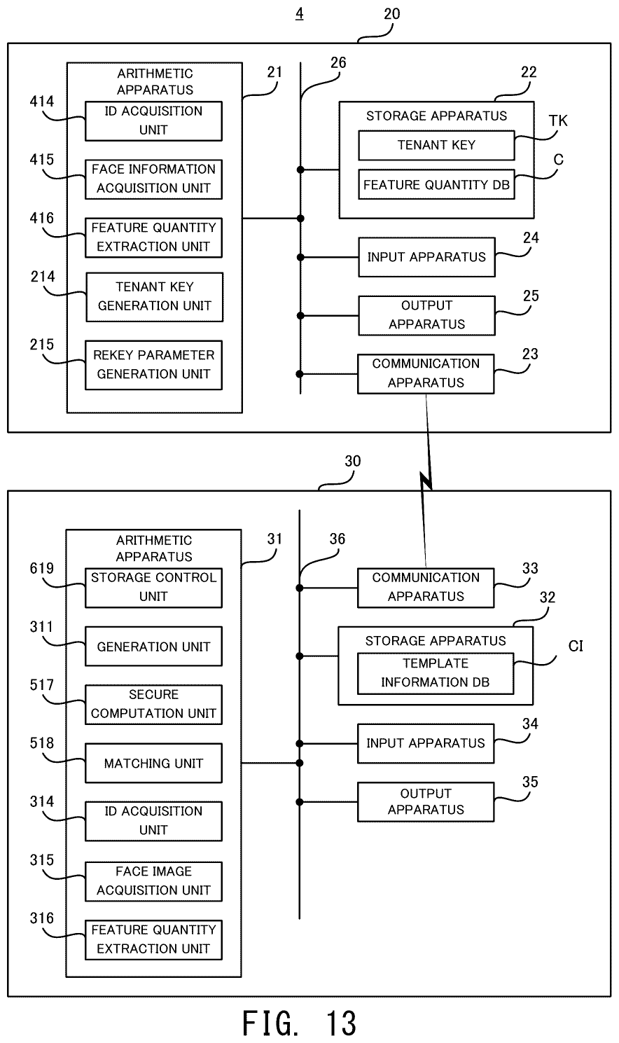

With reference to FIG. 13, a configuration of the information processing system 4 in the third example embodiment will be described. FIG. 13 is a block diagram illustrating the configuration of the information processing system 4 in the fourth example embodiment. In the following description, the already described components carry the same reference numerals, and a detailed description thereof will be omitted.

### [4-1: Configuration of Cloud Server 20]

FIG. 13 illustrates an example of the logical functional block realized or implemented in the arithmetic apparatus 21 to perform the biometric authentication operation. As illustrated in FIG. 13, the tenant key generation unit 214 that is a specific example of the “third encoding parameter generation unit, the ID acquisition unit 414, the face image acquisition unit 415, and the feature quantity extraction unit 416 are realized or implemented in the arithmetic apparatus 21.

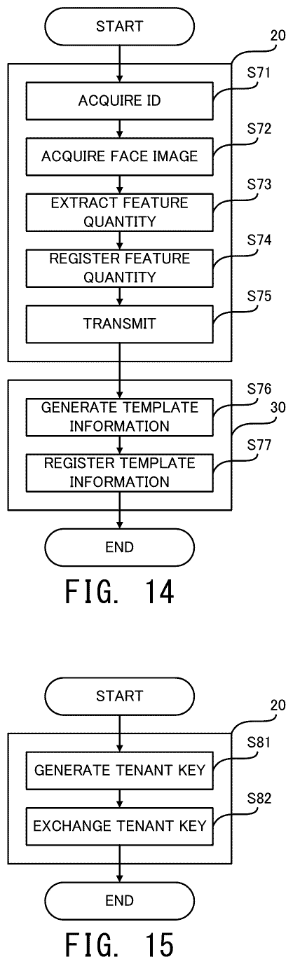

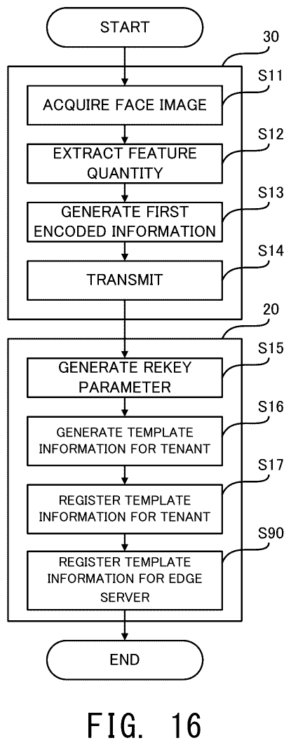

Details of operation of each of the tenant key generation unit 214, the ID acquisition unit 414, the face image acquisition unit 415, and the feature quantity extraction unit 416 will be described later with reference to FIG. 14 to FIG. 15.

### [4-2: Configuration of Edge Server 30]

FIG. 13 illustrates an example of the logical functional block realized or implemented in the arithmetic apparatus 31 to perform the biometric authentication operation. As illustrated in FIG. 9, the generation unit 311 that is a specific example of the “generation unit”, the secure computation unit 517 that is a specific example of the “secure computation unit”, the matching unit 518 that is a specific example of the “matching unit”, a storage control unit 619 that is a specific example of the “storage control unit”, the ID acquisition unit 314, the face image acquisition unit 315, and the feature quantity extraction unit 316 are realized or implemented in the arithmetic apparatus 31.

Details of operation of each of the generation unit 311, the ID acquisition unit 314, the face image acquisition unit 315, the feature quantity extraction unit 316, the secure computation unit 517, the matching unit 518, and the storage control unit 619 will be described later with reference to FIG. 14 to FIG. 15.

### [4-3: Template Information CI Registration Operation Performed By Information Processing System 4]

Next, with reference to FIG. 14, a template information CI registration operation performed by the information processing system 4 in the fourth example embodiment will be described. FIG. 14 is a flowchart illustrating a flow of the template information CI registration operation performed by the information processing system 4 in the fourth example embodiment.

Even in the fourth example embodiment, the target person may carry the BT terminal in the registration of the template information CI and in the matching of the test information TI. The BT terminal may store the ID information on the target person.

As illustrated in FIG. 14, the ID acquisition unit 414 acquires the ID information on the target person from the BT terminal (step S71). Subsequently, the face image acquisition unit 415 acquires the face image of the individual as the biometric information (step S72). The feature quantity extraction unit 416 extracts a feature quantity C of the face image (step S73).

The storage control unit 211 registers the extracted feature quantity C of the face image, in the DB of the feature quantity C built in the storage apparatus 22 (step S74). The storage control unit 211 transmits the extracted feature quantity of the face image to the edge server 30 through the communication apparatus 23 (step S75).

The step S71 to the step S75 described above are performed by the cloud server 20. A step S76 to a step S77 described below are performed by the edge server 30.

The storage control unit 619 generates the template information CI, by performing the encoding processing using the tenant key TK, on the feature quantity received through the communication apparatus 33, by using the secure computation unit 517 (step S76). The storage control unit 619 registers the template information CI, in the DB of the template information CI built in the storage apparatus 32 (step S77).

[4-4: Test information TI Matching Operation Performed By Information Processing System 4]

Since the information processing system 4 in the fourth example embodiment performs the test information TI matching in the same operation as that of the information processing system 3 in the third example embodiment, a detailed description thereof will be omitted.

### [4-5: Recovery Operations Performed By Information Processing System 4]

Next, with reference to FIG. 15, a recovery operation performed by the information processing system 4 in the fourth example embodiment will be described. FIG. 15 is a flowchart illustrating a flow of the recovery operation that is performed by the information processing system 4 in the fourth example embodiment. The information processing system 4 may perform the recovery operation in a case where at least one of the tenant key TK and the template information CI is leaked.

The tenant key generation unit 214 generates a new tenant key TK (step S81). The tenant key generation unit 214 exchanges the new tenant key TK with the older tenant key TK (step S82). The tenant key generation unit 214 may store the generated tenant key TK, for example, in the storage apparatus 22. The tenant key generation unit 214 may also discard the old tenant key TK. The tenant key generation unit 214 may discard the old tenant key TK stored in the storage apparatus 22, for example.

After the security of the edge server 30 is confirmed, the new tenant key TK may be transmitted from the cloud server 20 to the edge server 30.

Although exemplified is a case where the information processing system 3 in the third example embodiment and the information processing system 4 in the fourth example embodiment are applied to a payment processing in the tenant, the information processing system may be applied to an opening and closing processing of the gate of the tenant, as in the second example embodiment. The information processing system 3 in the third example embodiment and the information processing system 4 in the fourth example embodiment can be applied to a boarding gate at an airport, an entrance gate of a building, and the like.

### [4-5: Technical Effect of Information Processing System 4]

According to the information processing system 4 in the fourth example embodiment, since the template information CI is generated by using the tenant key TK in the secure computation unit 517, it is independent of other than the edge server 30, and even in the event of information leakage from the edge server 30, damage is not extended to other than the corresponding edge server 30, such as the cloud server 20.

Even in the second example embodiment, the face image acquisition unit 315 may acquire the ID of the target person from BT terminal in the step S11 of the registration operation, and the storage control unit 211 may register ID and the template information CI in association with each other in step S16. In this case, the face image acquisition unit 315 may acquire the ID of the target person from the BT terminal in the step S21 of the matching operation, and the matching unit 213 may match the ID with the template information CI in the step S28. That is, even in the second example embodiment, the one-to-one matching may be performed. Even in the second example embodiment, the information processing system 2 may be applied to a scene where at least one of the information processing system 3 in the third example embodiment and the information processing system 4 in the fourth example embodiment is applied for the facial authentication payment such as account payment/settlement.

### 5: Fifth Example Embodiment

Next, an information processing system, an information processing method, and a recording medium according to a fifth example embodiment will be described. The following describes the information processing system, the information processing method, and the recording medium according to the fifth example embodiment, by using an information processing system 5 to which the information processing system, the information processing method, and the recording medium according to the fifth example embodiment are applied.

The information processing system 5 in the fifth example embodiment may have the same configuration as that of the information processing system 2 in the second example embodiment. The storage apparatus 22 provided in the information processing system 5 in the fifth example embodiment may store a template information DB for the tenant and a template information DB for each edge server 30.

The information processing system 5 to which the fifth example embodiment is applied, may be applied to the personal authentication operation when the target person makes payment in a retail store, for example. The edge server 30 may be provided for each retail store. In the template information DB for each edge server 30 stored in the storage apparatus 22, the template information CI on the target person who often uses the corresponding edge server 30 may be registered. The template information CI registered in the template information DB for the tenant stored in the storage apparatus 22, may include template information CI registered in the template information DB of all the edge servers 30 corresponding to the same tenant.

### [5-1: Template Information CI Registration Operation Performed By Information Processing System 5]

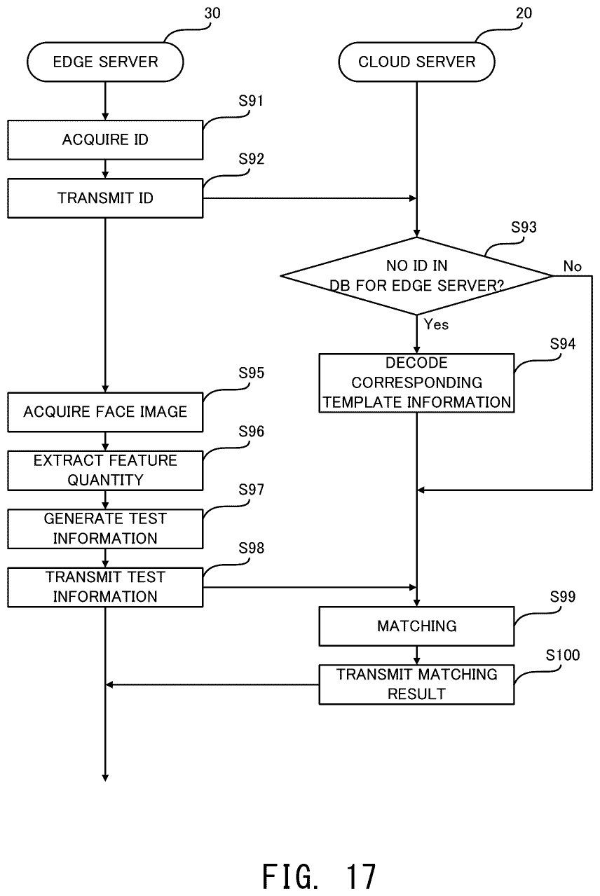

Next, with reference to FIG. 16, a template information CI registration operation performed by the information processing system 5 in the fifth example embodiment will be described. FIG. 16 is a diagram illustrating a flow of the template information CI registration operation that is performed by the information processing system 5 in the fifth example embodiment. The information processing system 5 in the fifth example embodiment may register the template information CI in both the template information DB for the tenant and the template information DB for each edge server 30.

A step S11 to a step S17 may be the same as the step S11 to the step S17 in the second example embodiment illustrated in FIG. 6.

In the step S11, the edge server 30 may acquire the face image of the individual as the biometric information, and may acquire the ID information on the target person from the BT terminal.

Furthermore, in the step S17, the storage control unit 211 may register the generated template information CI in the DB for the tenant built in the storage apparatus 22. Thus, the storage control unit 211 is capable of registering, in the DB for the tenant, the template information CI registered in the DB for all the edge servers 30 corresponding to the tenant.

The storage control unit 211 registers the first encoded information transmitted from the edge server 30, in the DB for the edge server 30, as the template information CI (step S90). Accordingly, the storage control unit 211 is capable of registering, in the DB for the edge server 30, the template information CI on the target person who often uses the edge server 30.

[5-2: Test information TI Matching Operation Performed By Information Processing System 5]

Next, with reference to FIG. 17, a test information TI matching operation performed by the information processing system 5 in the fifth example embodiment will be described. FIG. 17 is a diagram illustrating a flow of the test information TI matching operation performed by the information processing system 5 in the fifth example embodiment.

As illustrated in FIG. 17, the edge server 30 acquires the ID information on the target person from the BT terminal (step S91). For example, when the target person enters a store Ain which the edge server 30 is provided, the edge server 30 may acquire the ID information on the target person. Subsequently, the edge server 30 transmits the ID information on the target person received from the BT terminal, to the cloud server 20 (step S92). The edge server 30 may transmit the edge key EK together with the ID information on the target person.

The storage control unit 211 determines whether or not the template information CI corresponding to the ID information is registered in the DB for the edge server 30 that transmits the ID information (step S93). When the template information CI corresponding to the ID information is not registered (the step S93: No), the storage control unit 211 generates the first encoded information serving as the template information, by performing a decoding processing using the second encoding parameter, on the template information CI for the tenant stored in the storage apparatus 22 (step S94). The storage control unit 211 may perform the cancelable transformation processing using the tenant key TK and the edge key EK, thereby to generate the first encoded information serving as the template information. The storage control unit 211 registers the generated first encoded information, as the template information CI, in the DB for the edge server 30 that transmits the ID information. When the template information CI corresponding to the ID information is registered (the step S93: Yes), the operation proceeds to a step S99.

For example, suppose that the target person performs a registration processing of registering the template data CI in a store B corresponding to the same tenant, before entering the store A. The storage control unit 211 registers the template information CI on the target person in a DB for an edge server 30B provided in the store B and in the DB for the tenant, but does not register the template information CI on the target person in a DB for an edge server 30A provided in the store A. The facial recognition payment in the store A is performed on the basis of a matching result between the test information generated by using the edge key EK in the store A and the template information CI registered in the DB for the edge server 30A.

In a case where the target person performs the registration processing of registering the template data CI in the store B corresponding to the same tenant, before entering the store A, the storage control unit 211 registers the template information on the target person in the DB for the tenant. Using this, the storage control unit 211 is capable of performing the cancelable transform processing on the template information registered in the DB for the tenant, and registering the template information for the facial recognition payment in the store A, in the DB for the edge server 30A. Since the storage control unit 211 performs this processing at a timing when the target person enters the store A, it is possible to speed up a matching processing for the facial recognition payment.

For example, in a scene where the target person performs the facial recognition payment in the store A in which the edge server 30 is provided, the face image acquisition unit 315 acquires the face image of the individual face image as the biometric information (step S95). The feature quantity extraction unit 316 extracts the feature quantity of the face image (step S96). This feature quantity may be an example of the fourth confidential information.

The edge-side generation unit 311 generates the second encoded information, by performing the first encoding processing using the first encoding parameter, on the feature quantity (step S97). The transmission control unit 312 transmits the generated second encoded information to the cloud server 20 as the test information (step S98).

The matching unit 213 matches the template information CI for the edge server 30, with the test information TI transmitted from the edge server 30 (step S99). The cloud server 20 transmits a matching result to the edge server 30 (step S100). The edge server 30 may perform an operation corresponding to the matching result by the matching unit 213. For example, in a case where the edge server 30 is associated with a payment operation of the tenant 10, an operation of making payment may be performed when the matching result is OK, and an operation of not making payment may be performed when the matching result is NG, or a similar operation may be performed.

### [5-3: Technical Effect of Information Processing System 5]

According to the information processing system 5 to which the fifth example embodiment is applied, in a case where the template information CI corresponding to the ID information is not registered in the DB for the edge server 30 that transmits the ID information, the cancelable transformation processing may be performed on the template information CI for the tenant, thereby to generate the first encoded information. Since it is possible to generate the first encoded information serving as the template information CI before the matching processing, it is possible to speed up the matching processing.

### 6: Supplementary Notes

With respect to the example embodiments described above, the following Supplementary Notes are further disclosed.

### [Supplementary Note 1]

An information processing system including:
a storage control unit that stores, in a storage unit, template information generated by performing an encoding processing using an encoding parameter, on first confidential information;
a generation unit that generates test information, by performing the encoding processing using the encoding parameter, on second confidential information; and
a matching unit that matches the template information with the test information.

### [Supplementary Note 2]

The information processing system according to Supplementary Note 1, wherein
the information processing system includes an edge server and a cloud server,
the edge server includes:
an edge-side generation unit that generates first encoded information, by performing a first encoding processing using a first encoding parameter, on third confidential information; and
a transmission unit that transmits the first encoded information to the cloud server as the first confidential information,
the cloud server includes the storage control unit, the generation unit, and the matching unit, and
the storage control unit stores, in the storage unit, the template information generated by performing a second encoding processing using a second encoding parameter that is different from the first encoding parameter, on the first encoded information transmitted from the edge server as the first confidential information.

### [Supplementary Note 3]

The information processing system according to Supplementary Note 1 or 2, wherein
the information processing system includes an edge server and a cloud server,
the edge server includes:
an edge-side generation unit that generates second encoded information, by performing a first encoding processing using a first encoding parameter, on fourth confidential information; and
a transmission unit that transmits the second encoded information to the cloud server as the second confidential information,
the cloud server includes the storage control unit, the generation unit, and the matching unit, and
the generation unit generates the test information, by performing a second encoding processing using a second encoding parameter that is different from the first encoding parameter, on the second encoded information transmitted from the edge server as the second confidential information.

### [Supplementary Note 4]

The information processing system according to Supplementary Note 2, wherein
the edge server further includes an edge-side generation unit that generates second encoded information, by performing a first encoding processing using a first encoding parameter, on fourth confidential information,
the transmission unit transmits the second encoded information to the cloud server as the test information, and
the storage control unit generates the first encoded information serving as template information, by performing a decoding processing using the second encoding parameter, on the template information stored in the storage unit.

### [Supplementary Note 5]

The information processing system according to any one of Supplementary Notes 2 to 4, wherein the second encoding processing includes a cancelable transformation processing.

### [Supplementary Note 6]

The information processing system according to any one of Supplementary Notes 2 to 5, wherein the first encoding processing includes a cancelable transformation processing.

### [Supplementary Note 7]

The information processing system according to any one of Supplementary Notes 2 to 6, wherein the second encoding processing includes an encoding processing using the second encoding parameter and the first encoding parameter

### [Supplementary Note 8]

The information processing system according to any one of Supplementary Notes 2 to 7, wherein
the edge server further includes a first encoding parameter generation unit that generates the first encoding parameter.

### [Supplementary Note 9]

The information processing system according to any one of Supplementary Notes 2 to 8, wherein
the cloud server further includes a second encoding parameter generation unit that generates the second encoding parameter.

### [Supplementary Note 10]

The information processing system according to Supplementary Note 1, wherein
the information processing system includes an edge server and a cloud server,
the edge server includes:
a secure computation unit that performs secure computation while keeping information encrypted, that stores a third encoding parameter received from the cloud server, and that performs a third encoding processing using the third encoding parameter;
the storage unit;
the generation unit; and
the matching unit,
the storage control unit stores, in the storage unit, the template information generated by performing the third encoding processing on the first confidential information, and
the generation unit generates the test information by performing the third encoding processing on the second confidential information, by using the secret computation unit.

### [Supplementary Note 11]

The information processing system according to Supplementary Note 10, wherein
the information processing system includes a plurality of edge servers, and
the plurality of edge servers performs matching by using the template information stored by the same storage unit.

### [Supplementary Note 12]

The information processing system according to Supplementary Note 10 or 11, wherein
the cloud server includes the storage control unit, and
the storage control unit stores, in the storage unit, the template information generated by performing the third encoding processing on the first confidential information.

### [Supplementary Note 13]

The information processing system according to any one of Supplementary Notes 10 to 12, wherein
the edge server includes the storage control unit, and
the storage control unit stores, in the storage unit, the template information generated by performing the third encoding processing on the first confidential information, by using the secure computation unit.

### [Supplementary Note 14]

The information processing system according to any one of Supplementary Notes 10 to 13, wherein
the cloud server further includes a third encoding parameter generation unit that generates
the third encoding parameter.

### [Supplementary Note 15]

An information processing method including:
storing, in a storage unit, template information generated by performing an encoding processing using an encoding parameter, on first confidential information;
generating test information, by performing the encoding processing using the encoding parameter, on second confidential information; and
matching the template information with the test information.

### [Supplementary Note 16]

A recording medium on which a computer program that allows a computer to execute an information processing method is recorded, the information processing method including:
storing, in a storage unit, template information generated by performing an encoding processing using an encoding parameter, on first confidential information;
generating test information, by performing the encoding processing using the encoding parameter, on second confidential information; and
matching the template information with the test information.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is not limited to the examples described above and is allowed to be changed, if desired, without departing from the essence or spirit of this disclosure which can be read from the claims and the entire identification. An information processing system, an information processing method, and a recording medium with such changes are also intended to be within the technical scope of this disclosure.

### DESCRIPTION OF REFERENCE CODES

Information processing system 1, 2, 3, 4
Tenant 10
Cloud server 20
Edge server 30
Storage control unit 11, 211, 619
Generation unit 12
Matching unit 13, 213, 518
Cloud-side generation unit 212
Tenant key generation unit 214
Rekey parameter generation unit 215
Spoofing determination unit 216
Edge-side generation unit 311
Transmission control unit 312
Edge key generation unit 313
ID acquisition unit 314, 414
Face image acquisition unit 315, 415
Feature quantity extraction unit 316, 416
Secure computation unit 517
Edge key EK
Tenant key TK
Rekey parameter RKP
Template information CI
Test information TI

What is claimed is:

1. An information processing system comprising:
at least one memory that is configured to store instructions; and
at least one processor that is configured to execute the instructions to:
store, in a storage unit, template information generated by performing an encoding processing using an encoding parameter, on first confidential information;
generate test information, by performing the encoding processing using the encoding parameter, on second confidential information; and
match the template information with the test information.

2. The information processing system according to claim 1, wherein
the information processing system includes an edge server and a cloud server,
the edge server comprising:
at least one memory that is configured to store instructions; and
at least one first processor that is configured to execute the instructions to:
generate first encoded information, by performing a first encoding processing using a first encoding parameter, on third confidential information; and
transmit the first encoded information to the cloud server as the first confidential information,
the cloud server comprising:
at least one memory that is configured to store instructions; and
at least one second processor that is configured to execute the instructions to:
store, in the storage unit, the template information generated by performing a second encoding processing using a second encoding parameter that is different from the first encoding parameter, on the first encoded information transmitted from the edge server as the first confidential information;
generate the test information, by performing the encoding processing using the encoding parameter, on the second confidential information; and
match the template information with the test information.

3. The information processing system according to claim 1, wherein
the information processing system includes an edge server and a cloud server,
the edge server comprising:
at least one memory that is configured to store instructions; and
at least one first processor that is configured to execute the instructions to:
generate second encoded information, by performing a first encoding processing using a first encoding parameter, on fourth confidential information; and
transmit the second encoded information to the cloud server as the second confidential information,
the cloud server comprising:
at least one memory that is configured to store instructions; and
at least one second processor that is configured to execute the instructions to:
store, in a storage unit, template information generated by performing an encoding processing using an encoding parameter, on first confidential information;
generate the test information, by performing a second encoding processing using a second encoding parameter that is different from the first encoding parameter, on the second encoded information transmitted from the edge server as the second confidential information; and
match the template information with the test information.

4. The information processing system according to claim 2, wherein
the at least one first processor is configured to execute the instructions to:
generate second encoded information, by performing a first encoding processing using a first encoding parameter, on fourth confidential information; and
transmit the second encoded information to the cloud server as the test information,
the at least one second processor is configured to execute the instructions to:
generate the first encoded information serving as template information, by performing a decoding processing using the second encoding parameter, on the template information stored in the storage unit.

5. The information processing system according to claim 2, wherein the second encoding processing includes a cancelable transformation processing.

6. The information processing system according to claim 2, wherein the first encoding processing includes a cancelable transformation processing.

7. The information processing system according to claim 2, wherein the second encoding processing includes an encoding processing using the second encoding parameter and the first encoding parameter.

8. The information processing system according to claim 2, wherein the at least one first processor is configured to execute the instructions to:
generate the first encoding parameter.

9. The information processing system according to claim 2, wherein the at least one second processor is configured to execute the instructions to:
generate the second encoding parameter.

10. The information processing system according to claim 1, wherein
the information processing system includes an edge server and a cloud server,
the edge server comprising:
the storage unit;
at least one memory that is configured to store instructions; and
at least one first processor that is configured to execute the instructions to:
perform secure computation while keeping information encrypted, store a third encoding parameter received from the cloud server, and perform a third encoding processing using the third encoding parameter;
generate the test information by performing the third encoding processing on the second confidential information, by using the secret computation unit; and
match the template information with the test information,
the at least one processor is configured to execute the instructions to:
store, in the storage unit, the template information generated by performing the e third encoding processing on the first confidential information.

11. The information processing system according to claim 10, wherein
the information processing system includes a plurality of edge servers, and each of the plurality of edge servers comprising:
at least one memory that is configured to store instructions; and
at least one first processor that is configured to execute the instructions to:
perform matching by using the template information stored by the same storage unit.

12. The information processing system according to claim 10, wherein the cloud server comprising:
at least one memory that is configured to store instructions; and
at least one second processor that is configured to execute the instructions to:
store, in the storage unit, the template information generated by performing the third encoding processing on the first confidential information.

13. The information processing system according to claim 10, wherein the at least one first processor is configured to execute the instructions to:
store in the storage unit, the template information generated by performing the third encoding processing on the first confidential information, by performing the secure computation.

14. The information processing system according to claim 10, wherein the at least one second processor is configured to execute the instructions to:
generate the third encoding parameter.

15. An information processing method comprising:
storing, in a storage unit, template information generated by performing an encoding processing using an encoding parameter, on first confidential information;
generating test information, by performing the encoding processing using the encoding parameter, on second confidential information; and
matching the template information with the test information.

16. A non-transitory recording medium on which a computer program that allows a computer to execute an information processing method is recorded, the information processing method including:
storing, in a storage unit, template information generated by performing an encoding processing using an encoding parameter, on first confidential information;
generating test information, by performing the encoding processing using the encoding parameter, on second confidential information; and
matching the template information with the test information.
